(19) United States
(12) Patent Application Publication
(10) Pub. No.: US 2017/0356690 A1
(43) Pub. Date: Dec. 14, 2017

(54) REFRIGERANT HEAT EXCHANGER

(71) Applicant: DENSO CORPORATION, Kariya-city, Aichi-pref. (JP)

(72) Inventors: Kouhei NAKAMURA, Kariya-city (JP); Aun OTA, Kariya-city (JP); Tomohide NISHINO, Kariya-city (JP); Yoshiyuki YAMAUCHI, Kariya-city (JP); Takahito SHIBATA, Kariya-city (JP)

(21) Appl. No.: 15/541,595

(22) PCT Filed: Feb. 5, 2016
(86) PCT No.: PCT/JP2016/000603

§ 371 Date: Jul. 5, 2017

(30) Foreign Application Priority Data
Feb. 26, 2015 (JP) 2015-037254

(51) Int. Cl. F28D 1/04; B60H 1/32; F28F 21/02; F28F 1/16; F28F 3/12; F28F 21/06

(52) U.S. Cl. CPC F28D 1/04; F28F 3/12; F28F 21/06; F28F 21/02; F28F 1/16; B60H 1/32

(57) ABSTRACT

A refrigerant heat exchanger has the passage defining member. The passage defining member is made of carbon fiber reinforced plastics. The passage defining member has a tube portion defining a refrigerant passage. The passage defining member has the plate portion which spreads from the tube portion. In the tube portion, carbon fibers are oriented to surround the tube portion. This orientation contributes to a pressure resisting performance in a radial direction of the tube portion. In the plate portion, the carbon fibers are oriented to protrude from the tube portion. This orientation contributes to improve mechanical strength in the plate portion. The carbon fibers are extended over both the tube portion and the plate portion. This orientation promotes thermal transfer over the tube portion and the plate portion.

### CROSS REFERENCE TO RELATED APPLICATIONS

This application is based on a patent application No. 2015-37254 filed in Japan on February 26, 2015, and whole contents of which application are incorporated by reference.

### TECHNICAL FIELD

Disclosure in this specification relates to a refrigerant heat exchanger for heat exchange between a refrigerant for a refrigeration cycle and a heat medium.

### BACKGROUND

Patent Literature 1 and Patent Literature 2 disclose heat exchangers which use a carbon fiber reinforced polymer (CFRP). Patent Literature 1 discloses the heat exchanger which uses CFRP for a tube and a fin. Patent Literature 2 indicates the heat exchanger which uses CFRP for a tube.

### CITATION LIST

### Patent Literature

Patent Literature 1: JP2008-138968A

Patent Literature 2: JP3140963U

### SUMMARY

The Patent Literature 1 and Patent Literature 2 disclose no refrigerant heat exchanger which can be used with a refrigerant for a refrigeration cycle. In these conventional techniques, it is difficult to achieve a pressure-resistant property that can be withstood in a use of a refrigerant in a tube. In the above viewpoint, or in the other viewpoint not mentioned above, further improvement of a refrigerant heat exchanger is still demanded.

It is an object of disclosure to provide a light weight refrigerant heat exchanger.

It is another object of disclosure to provide a refrigerant heat exchanger having a high pressure-resistant property in a tube.

It is still another object of disclosure to provide a refrigerant heat exchanger having a high heat exchange property.

The present disclosure employs the following technical means, in order to attain the above-mentioned object. The symbols in the parenthesis indicated in the claims and/or this section merely show correspondence relations with concrete elements described in embodiments later mentioned as one example, and are not intended to limit the technical scope of this disclosure.

According to one disclosure, a refrigerant heat exchanger which provides a heat exchange between a refrigerant for a refrigeration cycle and a heat exchange medium is provided. The refrigerant heat exchanger has a passage defining member made of carbon fiber reinforced plastics, which provides a tube portion to define a refrigerant passage where the refrigerant of the refrigeration cycle flows.

The tube portion, which defines the refrigerant passage, is provided by the member made of carbon fiber reinforced plastics. In the refrigeration cycle, the refrigerant in a pressurized state or in a decompression state flows in the refrigerant passage. Carbon fiber reinforced plastics provide mechanical strength which can bear the pressure difference between the inside and outside of the refrigerant passage. In addition, since the carbon fibers contained in carbon fiber reinforced plastics have high thermal conductivity, it promotes the thermal transfer passing through the member itself. As a result, a lightweight refrigerant heat exchanger is provided.

### BRIEF DESCRIPTION OF THE DRAWINGS

FIG. 1 is a block diagram showing a refrigeration cycle according to a first embodiment;

FIG. 2 is a frontal view showing a refrigerant heat exchanger;

FIG. 3 is a cross sectional view on a line III-III in FIG. 2 showing a refrigerant heat exchanger;

FIG. 4 is a cross sectional view on a line IV-IV in FIG. 2 showing a refrigerant heat exchanger;

FIG. 5 is a perspective diagram showing a plate of a refrigerant heat exchanger;

FIG. 6 is an enlarged cross-sectional view showing a passage defining member of a refrigerant heat exchanger;

FIG. 7 is a perspective diagram showing the passage defining member of a refrigerant heat exchanger;

FIG. 8 is a process diagram showing a manufacturing method of a refrigerant heat exchanger;

FIG. 9 is a cross-sectional view showing a passage defining member according to a second embodiment; and

FIG. 10 is a partial cross-sectional view showing a refrigerant heat exchanger according to a third embodiment.

### DETAILED DESCRIPTION

A plurality of embodiments is described referring to the drawings. In the embodiments, the same reference number is used for components corresponding to facts which are described in the previous embodiments, and the same descriptions can be referenced for the components. In a consecutive embodiment, reference symbol, in which only hundred and more digits differ from, may be used for components corresponding to facts which are described in the previous embodiments. In a case that only a part of component or part is described, other descriptions for the other embodiment may be referenced or incorporated as descriptions for the remaining part of component or part.

### First Embodiment

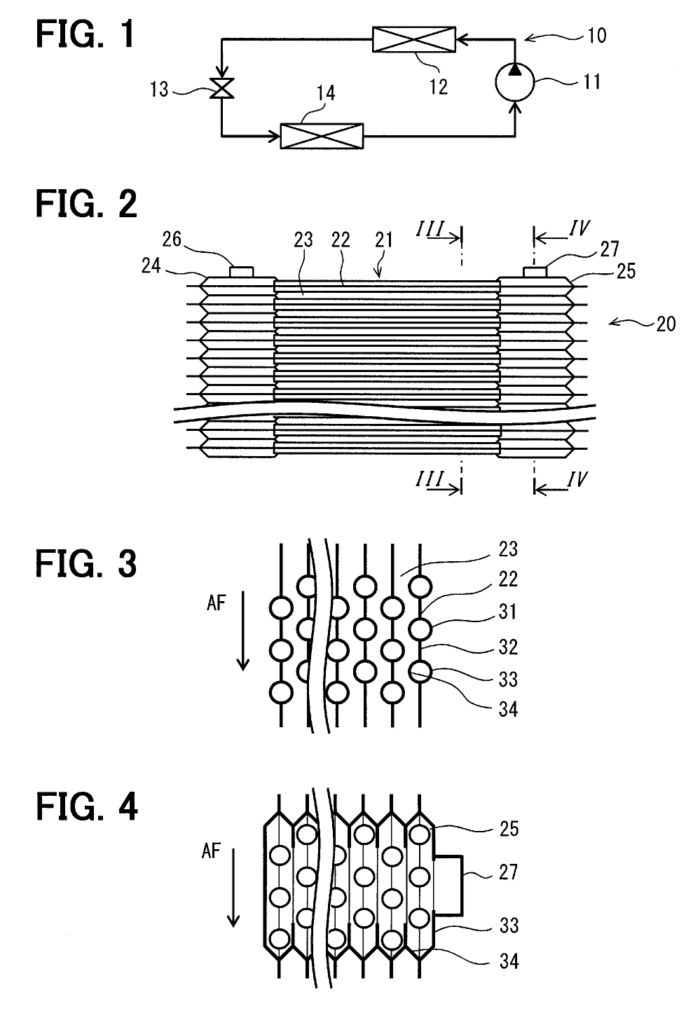

In FIG. 1, the refrigeration cycle 10 is a thermal-energy mechanism using a heat absorption and/or heat dissipation accompanying a phase change of a refrigerant. The refrigerant may be provided with various refrigerants, such as fluorocarbon system refrigerants and natural refrigerants, such as a carbon dioxide. The refrigeration cycle 10 is a steam compression type refrigeration cycle which produces a phase change by pressuring a refrigerant or decompressing a refrigerant, and produces heat absorption and/or heat dissipation. The refrigeration cycle 10 may be used for an air-conditioner, a cold storage facility, etc. In this embodiment, the refrigeration cycle 10 is used for the air-conditioner for air-conditioning a room of a vehicle. The refrigeration cycle 10 is mounted on the vehicle. Therefore, lightweight is demanded for the refrigeration cycle 10.

The refrigeration cycle 10 has the compressor 11 which compresses a refrigerant. The refrigeration cycle 10 has a radiator 12 which radiate heat from the refrigerant of high temperature and high pressure which is compressed by the compressor 11. In a case of the refrigerant condenses, the radiator 12 may be also called a condenser. The refrigeration cycle 10 has a decompressing device 13 which decompresses the refrigerant cooled by the radiator 12. The refrigeration cycle 10 has a heat absorber 14 which make the refrigerant of low temperature and low pressure decompressed by the decompressing device 13 to absorb heat. When the refrigerant evaporates, the heat absorber 14 may be also called an evaporator.

Either at least one of the radiator 12 or the heat absorber 14 is used as a using side heat exchanger for air conditioning. The other one of the radiator 12 and the heat absorber 14 functions as an un-using side heat exchanger. For example, when the air-conditioner is used for a cooling application, the heat absorber 14 is used as a using side heat exchanger, in order to cool the medium for air conditioning, for example, air. In this case, the radiator 12 is used in order to discharge a thermal energy as an un-using side heat exchanger.

The radiator 12 and the heat absorber 14 are refrigerant heat exchangers in the refrigeration cycle. Since the refrigerant is pressurized or decompressed, the refrigerant heat exchanger is required to have high resistance to pressure. For example, the radiator 12 is required to bear strength withstand against high pressure of an internal refrigerant. The heat absorber 14 is required to bear strength withstand against low pressure of an internal refrigerant.

The radiator 12 and the heat absorber 14 are required to demonstrate high heat exchanging performance as heat exchangers. In a case that the medium which performs heat exchange to the refrigerant is air, a refrigerant heat exchanger is required to provide high heat transfer performance between the refrigerant and air. Therefore, the member forming the refrigerant heat exchanger is required to provide high heat transfer performance between the refrigerant and air.

In this embodiment, a novel refrigerant heat exchanger which can be used as the radiator 12 and/or the heat absorber 14 for the refrigeration cycle is provided. In this embodiment, a novel refrigerant heat exchanger which can be used as a heat absorber 14 is provided.

In FIG. 2, the refrigerant heat exchanger 20 provides the heat exchange between the refrigerant in the refrigeration cycle and the air as a heat exchange medium. The refrigerant heat exchanger 20 can be used as the heat absorber 14. The refrigerant heat exchanger 20 has a heat exchange portion 21 and tank parts 24 and 25. The heat exchange portion 21 has a plurality of passage defining members 22. The refrigerant heat exchanger 20 can have support parts for supporting the refrigerant heat exchanger 20 to the air-conditioner. The heat exchange portion 21 of the refrigerant heat exchanger 20 and the tank parts 24 and 25 are made of carbon fiber reinforced plastics (CFRP). The support parts may also be made of CFRP.

A plurality of passage defining members 22 define the refrigerant passage where the refrigerant flows. Since the passage defining member 22 defines the tube in which the refrigerant flows, it is also called a tube member. Since the passage defining member 22 has a tabular appearance and defines the refrigerant passage in it, it is also called a heat exchange board. A plurality of passage defining members 22 defines the air passageway 23 in which air flows. A plurality of passage defining members 22 are also heat transfer members which bear the heat transfer between the refrigerant and air. A plurality of passage defining members 22 are arranged in a stacking manner to become parallel each other. A plurality of passage defining members 22 are arranged with predetermined clearances so as to define the air passageways 23 among them. The air passageway 23 is a passage where the air for the air conditioning as a medium to be cooled flows.

The tank part 24 is an inlet tank which receives the refrigerant from the decompressing device 13 and distributes the refrigerant to a plurality of passage defining members 22. An inlet pipe 26 is disposed on the tank part 24. The tank parts 25 is an exit tank which collects the refrigerant from a plurality of passage defining members 22, and supplies it to a compressor 11. An outlet pipe 27 is disposed on the tank part 25. A plurality of passage defining members 22 are arranged between the tank part 24 and the tank part 25. A plurality of passage defining members 22 communicates an internal chamber of the tank part 24, and an internal chamber of the tank part 25.

FIG. 3 shows a cross-section on a line III-III line shown in FIG. 2. This cross section illustrates a vertical cross section to the refrigerant flow direction of the passage defining member 22, i.e., vertical cross section to a longitudinal direction of the passage defining member 22. FIG. 4 shows a cross-section on a line IV-IV in FIG. 2.

The passage defining member 22 has tube portion 31. The tube portion 31 provides the tube in which the refrigerant flows. The tube portion 31 defines the refrigerant passage inside of the tube portion 31. The tube portion 31 can have various sectional shapes, such as circular, a long circle, and a polygon. In this embodiment, the tube portion 31 has a circular cross section. One passage defining member 22 may be disposed with one or more tube portions 31. In this embodiment, three tube portions 31 are disposed in one passage defining member 22. The tube portion 31 communicates with the internal chamber of the tank parts 24 and 25 on both ends of the passage defining member 22. The tube portion 31 communicates both the internal chamber of the tank part 24 and the internal chamber of the tank part 25 by the refrigerant passage therein.

The passage defining member 22 has plate portions 32 which protrude from the tube portion 31. A part of the plate portion 32 is disposed on a leading edge of the passage defining member 22 to provide the leading edge of the passage defining member 22 with respect to an air flow direction AF. A part of the plate portion 32 is disposed on a trailing edge of the passage defining member 22 to provide the trailing edge of the passage defining member 22 with respect to the air flow direction AF. A part of the plate portion 32 is disposed between two tube portions 31.

The plate portion 32 protrudes from the tube portion 31 in a spreading manner. The plate portion 32 spreads among a plurality of tube portions 31. The plate portion 32 connects between two adjoining tube portions 31. The plate portion 32 spreads over the tank part 24 and the tank part 25. The plate portion 32 contributes to increase the mechanical strength of the passage defining member 22. The plate portion 32 is a heat transfer member which is disposed on the outside of the tube portion 31, and which is a member for widening a contact-surface to air which is the heat exchange medium. The plate portion 32 is provided by the passage defining member 22, and is made of CFRP. The plate portion 32 contributes to enlarge surface area on which the passage defining member 22 and air contact. The plate portion 32 may also be called a fin portion.

The tube portion 31 forms a projection which projects towards the air passageway 23 from the plate portion 32. In other words, the plate portion 32 forms a recessed portion between two tube portions 31. Further, the passage defining member 22 which adjoins each other are arranged so that those tube portions 31 may shift with respect to the air flow direction AF. As a result, the air passageway 23 defined between the passage defining members 22 is formed in a winding manner with respect to the air flow direction AF. Such arrangement promotes the heat transfer between the passage defining member 22 and air.

A blower of the air-conditioner makes to flow air in the air passageway 23 defined between the passage defining members 22. Air flows to cross the longitudinal direction of the tube portion 31. Air flows in parallel with the plate portion 32. Since the refrigerant heat exchanger 20 is used as the heat absorber 14, condensed water adheres on an outside surface of the tube portion 31 and the plate portion 32. In this embodiment, the refrigerant heat exchanger 20 is installed in an air-conditioner so that the plate portion 32 may spread almost in parallel with the gravity direction. Such an installment of the refrigerant heat exchanger 20 promotes draining flow of the condensed water.

One passage defining member 22 is formed by stacking plates 33 and 34. In this embodiment, one passage defining member 22 is formed by stacking and joining two independent plates 33 and 34. One passage defining member 22 may be formed by bending one plate and joining it.

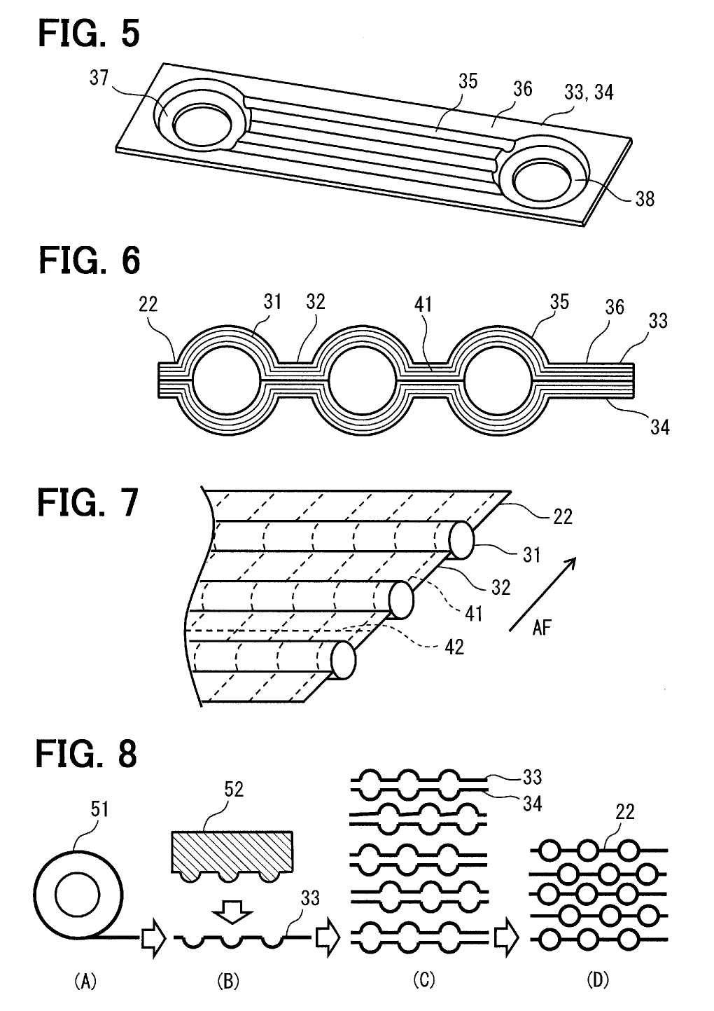

In FIG. 5, the first plate 33 and the second plate 34 which form the passage defining member 22 have shapes corresponding to the refrigerant heat exchanger 20. The plates 33 and 34 are long and narrow shape. In the illustrated example, the plates 33 and 34 may be called a quadrilateral or a rectangle. The plates 33 and 34 are made of CFRP.

The plates 33 and 34 have grooved portions 35 for forming the tube portion 31, and flat plate portions 36 in a flat surfaced shape for forming the plate portion 32. The grooved portion 35 is dented from the flat plate portion 36 on one surface of the plates 33 and 34, on the other surface, is projected from the flat plate portion 36. The plates 33 and 34 have recessed portions 37 and 38 for forming the tank parts 24 and 25. The recessed portions 37 and 38 are dented from the flat plate portion 36 on one surface of the plates 33 and 34, on the other surface, are projected from the flat plate portion 36. Both ends of the grooved portion 35 reach the recessed portions 37 and 38. Both ends of the grooved portion 35 open toward the recessed portions 37 and 38. One passage defining member 22 is formed by stacking the plates 33 and 34 face to face. The first plate 33 and the second plate 34 have a symmetrical shape with respect to attaching surfaces of them.

FIG. 6 shows modeled cross section of the passage defining member 22. These plates 33 and 34 contain the resin material and the carbon fibers 41 which constitute CFRP. In the drawing, in order to show the orientation direction of the carbon fibers 41, a representative carbon fiber 41 is illustrated as a thin solid line in the cross section. FIG. 7 is a partial cross-sectional and perspective diagram of the passage defining member 22. In the drawing, in order to show the orientation direction of the carbon fibers 41, a representative carbon fiber 41 is illustrated as a broken line. The carbon fibers 41 have high thermal conductivity. The carbon fibers 41 have thermal conductivity far higher than the resin material which constitutes CFRP. Therefore, the carbon fibers 41 have large influence on transferring of the thermal energy in the passage defining member 22.

The carbon fibers 41 used in this embodiment are longer than the thickness of the plates 33 and 34. The carbon fibers 41 has length over from an end to an end of the plates 33 and 34 with respect to a width direction of the plates 33 and 34, i.e., a direction which intersects perpendicularly with the longitudinal direction of the refrigerant passage which the tube portion 31 provides. The carbon fibers 41 are provided by a cross which wove the carbon fibers. Therefore, the plates 33 and 34 contain the carbon fibers 42 which extend to intersect perpendicularly with the carbon fibers 41. The carbon fibers 42 are extended along with the longitudinal direction of the tube portion 31.

Alternative to the illustrated example, relatively short carbon fibers may be used. For example, in a case that many short carbon fibers are used, those short carbon fibers are oriented in the same direction of the carbon fibers 41 illustrated. In addition, the carbon fibers 41 may be arranged only in the single direction.

In the tube portion 31, the carbon fibers 41 are oriented to extend to surround the refrigerant passage. In the illustrated example in which the tube portion 31 has a circular cross sectional shape, the carbon fibers 41 are oriented to extend along a circumferential direction of the tube portion 31. In other words, in the cross section vertical to the longitudinal direction of the refrigerant passage which the tube portion 31 provides, the carbon fibers 41 are oriented to extend in parallel to the cross section. Such orientation of the carbon fibers 41 contributes to increase the pressure resistance with respect to the radial direction in the tube portion 31.

In the plate portion 32, the carbon fibers 41 are oriented to extend in a direction which intersects the longitudinal direction of the refrigerant passage which the tube portion 31 provides, for example, the direction which intersects perpendicularly. Such orientation promotes the heat conduction in the plate portion 32, and contributes to suppress the temperature distribution in the plate portion 32.

In the plate portion 32, the carbon fibers 41 are oriented to protrude from the tube portion 31. The carbon fibers 41 are extended in an inside of the plate portion 32 to protrude from the tube portion 31. This orientation may contribute to promote the thermal transfer between the tube portion 31 and the plate portion 32.

In addition, the carbon fibers 41 are extended over both the tube portion 31 and the plate portion 32 in a continuous manner. Utilization of such long carbon fibers 41 and/or such orientation of the carbon fibers 41 promote further the thermal transfer between the tube portion 31 and the plate portion 32.

In the plate portion 32, the carbon fibers 41 are extended to connect between two adjoining tube portions 31. Such the orientation improves the mechanical strength with respect to the width direction of the passage defining member 22. The carbon fibers 41 is extended over the overall width of the passage defining member 22 along with the air flow direction AF of air which is a heat exchange medium. The carbon fibers 41 are extended over all the plurality of the tube portions 31 and the plurality of the plate portions 32.

Above explained orientation of the carbon fibers 41 in the tube portions 31 and/or the plate portions 32 make it possible to make thickness of the passage defining member 22 thin. The thin passage defining member 22 makes the refrigerant heat exchanger 20 possible to become lightweight. In addition, the thin passage defining member 22 promotes further the thermal transfer between the refrigerant and air.

FIG. 8 shows main processes in a manufacturing method of the refrigerant heat exchanger 20. The manufacturing method of the refrigerant heat exchanger 20 has process described below. The first process A is a process of supplying a raw material for the plates 33 and 34. At this process, a prepreg for CFRP is supplied. Prepreg is supplied where impregnation of the resin material is carried out to carbon fibers. Prepreg, resin material is selected to have the workability and the cure characteristic which are suitable for consecutive process. Thermosetting resin or thermoplastic resin may be used for the resin material of prepreg. Prepreg is supplied as a roll material 51.

The second process B is a process of processing a raw material into the shape of the plates 33 and 34. At this process, prepreg is cut into a predetermined scale and is given a predetermined shape. Prepreg is formed into a shape corresponding to the plates 33 and 34. For example, the shape of the plates 33 and 34 is formed by pressing work using a pressing machine 52.

The third process C is a process of arranging a plurality of plates 33 and 34 in a stacking manner so that the refrigerant heat exchanger 20 may be formed. At this process, a plurality of plates 33 and 34 are stacked regularly. At this process, a set of symmetrical plates 33 and 34 are stacked each other for one passage defining member 22. And then at this process, two or more sets of plates 33 and 34 for forming the refrigerant heat exchanger 20 are stacked. The fourth process D is a process which joins the plates 33 and 34 and stiffens prepreg.

The carbon fibers 41 may be obtained as “PYROFIL” which Mitsubishi Rayon Co., Ltd. sells. The carbon fibers 41 may be obtained as UD tape in which fibrous direction is a uni-directional manner, a fabric sheet as a fabric, or discontinuous base material, such as chopped fibers. The carbon fibers 41 may be obtained as a “TORAYCA” which Toray Industries, Inc. sells. The carbon fibers 41 may be obtained as UD tape in which fibrous direction is a uni-directional manner, a fabric sheet as a fabric, or discontinuous base material, such as cut fibers or short fiber pellets. The carbon fibers 41 may be obtained as “DIALEAD” which Mitsubishi

Plastics Inc. sells. The carbon fibers 41 may be obtained as UD tape in which fibrous direction is a uni-directional manner, a fabric sheet as a fabric, or discontinuous base material, such as chopped fibers, short fiber pellets, or milled fibers which are grounded a fiber into short.

When UD tape or a fabric seat is used, prepreg is provided by impregnating the resin material to the carbon fibers 41 of which the longitudinal direction is positioned in a direction required as the plates 33 and 34. When the discontinuous base material called chopped fibers, cut fibers, or short fiber pellets are used, the plates 33 and 34 are formed by injection molding by using the resin material with which the discontinuous base material is mixed. In this case, the carbon fibers are oriented along the direction of flow of the resin material in the injection molding process. Therefore, location of gates in the injection molding mold is set so that a resin material may flow in a direction which intersects the longitudinal direction of the tube portion 31.

When thermosetting resin is used as a resin material to be impregnated the carbon fibers 41, the manufacturing method process may use a vacuum heat pressing process by an autoclave, a resin injection forming process called an RTM (Resin Transfer Molding) process, or a suction type resin injection forming step called a VaRTM (Vacuum Resin Transfer Molding) process. In addition, when thermoplastic resin is used as a resin material to be impregnated the carbon fibers 41, a stamp-press process (Stamping Molding) or an injection molding process (Injection Molding) may be used for the manufacturing method process.

According to this embodiment, since CFRP is used for the passage defining member 22 which is a refrigerant passage forming member of the refrigerant heat exchanger 20, a refrigerant passage forming member can be formed thin and lightweight. As a result, a lightweight refrigerant heat exchanger is provided. According to this embodiment, the carbon fibers 41 are oriented to surround the tube portion 31. Accordingly, the refrigerant heat exchanger which has high pressure resisting performance is provided with respect to the radial direction of the tube portion 31. According to this embodiment, in the plate portion 32, the carbon fibers 41 are oriented to protrude from the tube portion 31. Accordingly, the refrigerant heat exchanger which has high heat exchanging performance between the refrigerant in the tube portion 31 and the medium on the outside of the plate portion 32 is provided.

### Second Embodiment

This embodiment is a modification based on a basic form provided by the preceding embodiment. In the preceding embodiment, the tube portion 31 defines the refrigerant passage in the circular sectional shape. Alternatively, the passage defining member 22 may be formed to define refrigerant passages which have various sectional shapes.

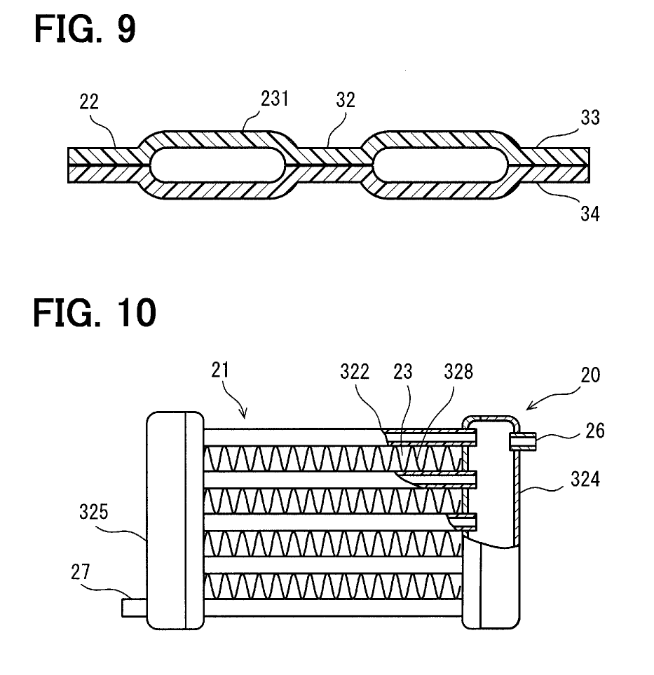

As shown in FIG. 9, the passage defining member 22 of this embodiment have a tube portion 231. The tube portion 231 defines the refrigerant passage having a sectional shape which may be called a rectangle or an ellipse. According to this embodiment, the contact surface of the refrigerant and plates 33 and 34 is formed over wide area. In addition, a flat shaped area over a large area is disposed on the outer surface of the passage defining member 22. Such a shape makes it possible to provide a heat exchanging performance which suited the application of the refrigerant heat exchanger 20.

### Third Embodiment

This embodiment is a modifications based on a basic form provided by the preceding embodiment. In the preceding embodiments, the refrigerant heat exchangers 20 may belong to the types called the stacked plate type or the drawn cup type. Alternatively, the refrigerant heat exchanger 20 may be provided by various types.

The refrigerant heat exchanger 20 illustrated in FIG. 10 belongs to a type called the tube and header type. One application of the refrigerant heat exchanger 20 illustrated is the radiator 12.

The refrigerant heat exchanger has a passage defining member 322. Also this embodiment, the passage defining member 322 forms the refrigerant passage where the refrigerant flows. The passage defining member 322 does not have the recessed portions 37 and 38 and the peripheral portions among the passage defining members 22 of the preceding embodiments, but has only portions corresponding to the tube portion 31 and the plate portion 32. Therefore, the passage defining member 322 is formed to provide the refrigerant passage mainly. In this embodiment, the air passageway 23 is formed among a plurality of passage defining members 322 too. Fin 328 thermally connected to the passage defining member 322 is arranged in the air passageway 23. The fin 328 is a heat transfer member which is disposed on the outside of the tube portion 31 and which widens a contact-surface with the air which is a heat exchange medium. The fin 328 is a member other than the passage defining member 322.

In the illustrated example, the fin 328 is provided by a wavelike member called a corrugate fin. The fin 328 is made of material which is possible to join to the passage defining member 322 made of CFRP in a thermally and mechanically manner. The fin 328 is made of CFRP. In a case of joining the fin 328 to the passage defining member 22, the fin 328 may be made of metal, such as aluminum.

The refrigerant heat exchanger 20 has header tanks 324 and 325 to which the ends of a plurality of passage defining members 322 are fluidly communicated. The header tanks 324 and 325 are made of metal, such as aluminum, or made of CFRP. The passage defining member 22 communicates the refrigerant chamber defined within the header tanks 324 and 325.

### Other Embodiments

The present disclosure is not limited to the above embodiments, and the present disclosure may be practiced in various modified embodiments. The present disclosure is not limited to the above combination, and disclosed technical means can be practiced independently or in various combinations. Each embodiment can have an additional part. The part of each embodiment may be omitted. Part of embodiment may be replaced or combined with the part of the other embodiment. The configurations, functions, and advantages of the above-mentioned embodiments are just examples. Technical scope of disclosure is not limited to the embodiments. It should be understood that some disclosed technical scope may be shown by description in the scope of claim, and contain all modifications which are equivalent to and within description of the scope of claim.

In the preceding embodiment, the carbon fibers 41 are disposed in whole of the passage defining member 22. Alternatively, the carbon fibers 41 may be disposed in a part of the passage defining member 22. For example, the carbon fibers 41 may be disposed in a part being required to have high mechanical strength, and/or a part which needs high thermal transfer nature. Further, in addition to the above-mentioned embodiments, it may be possible to add additional carbon fibers to a part being required to have high mechanical strength, and/or a part which needs high thermal transfer nature.

What is claimed is:

1. A refrigerant heat exchanger providing heat exchange between a refrigerant for a refrigeration cycle and a heat exchange medium, the refrigerant heat exchanger comprising:
a passage defining member made of carbon fiber reinforced plastics, the passage defining member providing a tube portion to define a refrigerant passage where the refrigerant of the refrigeration cycle flows.

2. The refrigerant heat exchanger claimed in claim 1, wherein
carbon fibers contained in the carbon fiber reinforced plastics extend to surround the refrigerant passage.

3. The refrigerant heat exchanger claimed in claim 1, further comprising:
a heat transfer member for widening a contact-surface with the heat exchange medium, which is disposed on an outside of the tube portion.

4. The refrigerant heat exchanger claimed in claim 3, wherein
the heat transfer member is provided by the passage defining member and is made of the carbon fiber reinforced plastics.

5. The refrigerant heat exchanger claimed in claim 4, wherein
the heat transfer member is a plate member protrudes from the tube portion.

6. The refrigerant heat exchanger claimed in claim 5, wherein
carbon fibers contained in the carbon fiber reinforced plastics extend in the plate member to protrude from the tube portion.

7. The refrigerant heat exchanger claimed in claim 5, wherein
the carbon fibers contained in the carbon fiber reinforced plastics are extended over both the tube portion and the plate portion.

8. The refrigerant heat exchanger claimed in claim 7, wherein
the carbon fibers are extended over the entire width of the passage defining member along a flow direction of the heat exchange medium.

9. The refrigerant heat exchanger claimed in claim 6, wherein
the passage defining member has a plurality of tube portions and a plurality of plate portions, and wherein
the carbon fibers extend over all of the plurality of tube portions and the plurality of plate portions.

10. The refrigerant heat exchanger claimed in claim 3, wherein
the heat transfer member is a member other than the passage defining member.
